(19) United States
(12) Patent Application Publication
(10) Pub. No.: US 2007/0050402 A1
(43) Pub. Date: Mar. 1, 2007

(54) Linking DVDs to the internet

(76) Inventors: James Abram Wessel JR., Seattle, WA (US); Chris Brown, Manhattan Beach, CA (US)

Correspondence Address: FISH & RICHARDSON, PC, P.O. BOX 1022, MINNEAPOLIS, MN, 55440-1022, US

(21) Appl. No.: 11/515,417

(22) Filed: Sep. 1, 2006

Related U.S. Application Data
(60) Provisional application No. 60/713,598, filed on Sep. 1, 2005.

(51) Int. Cl. G06F 7/00

(52) U.S. Cl. 707/102

(57) ABSTRACT

A method and system for communicatively linking one or more items of digital content to a fixed media for presenting to a user. A graphical user interface capable of receiving data from a user is provided. The received data can be used to identify the one or more items of digital content to be linked to the fixed media. Based on the received data and a private seed value, a hash file is generated, the hash file includes a first hash code. An executable file is also generated. Also, an output file including the hash file and the executable file is generated. The generated output file is stored on a fixed media object.

This application claims priority to U.S. Provisional Application Ser. No. 60/713,598, filed on Sep. 1, 2005. The contents of U.S. Application Ser. No. 60/713,598 are incorporated by reference as part of this application.

### TECHNICAL FIELD

The subject matter described herein relates to linking a DVD or similar fixed media to specified content for presenting to an end user during a playback of the fixed media.

### BACKGROUND

In general, opportunities for an end user to experience supplemental content linked to fixed media are limited. For example, there are the occasional music CDs that include ROM content that an end user can access manually. As used herein, “ROM Content” refers to content designed to be accessed by a computer system, such as a PC or Apple® Macintosh that has the capability of playing music CDs. Typically, most conventional music CD players are not equipped to allow a listener to access any ROM content on a music CD. An end user often is prompted to make a choice to listen to the main content (music files) or access the ROM content. In some instances, the end user may be required to acquire a special application (e.g., a media player) in order to access the ROM content.

For the few providers (e.g., movie studios, record labels) of content (e.g. movies, music) on fixed media that includes supplemental content linked to the main content, the process of authoring the supplemental content has not been simplified or standardized. Often times, these providers rely on a third party to create the supplemental content.

### SUMMARY

Techniques for linking DVD or similar fixed media to a specified content for presenting to an end user are described.

The present inventors have recognized that the conventional system for linking DVDs or similar media to content or applications residing locally or remotely via the Internet suffers from many problems. For example, conventional systems tend not to be automated and/or require end users to make step-by-step decisions in accessing the linked content for viewing or playback, etc. Also, conventional systems typically requires end users to install additional software or hardware in order to view the linked content. In addition, the media production tasks necessary to define a fixed media launch sequence that blends a combination of media types from a variety of sources often are complicated. Further, conventional systems often require the use of an end user interface.

In recognition of the difficulties encountered by authors of DVD and other similar media in linking the media to one or more specified contents for presenting to end users, the present inventors have come up with, inter alia, a novel process and system for linking media with specified content. Certain implementations may provide one or more of the following advantages. A system designed in accordance with the disclosed techniques may require end users to make few if any decisions. A system can be designed to work “in the background” (i.e., without necessitating user intervention in most instances) to locate, manage and launch all applications as needed. The present system may not require end users to install any additional software or hardware. The present system may simplify the production tasks necessary to define a fixed media launch sequence that blends a combination of media types from a variety of sources, both on disc and online. Unlike conventional systems, the system as disclosed herein does not require the use of an end user interface, but instead executes a startup sequence that includes one or more programs. Consequently, end users need not learn a new user interface, but can rather play the DVD or other similar media and/or browse the web using the user interfaces with which they are already familiar.

Further, the present system enables the presentation of content stored online or on a ROM partition of the DVD or similar media while preserving the computer's default media insertion startup sequence. Unlike conventional systems that link DVDs or similar media to the Internet, the present system minimizes or eliminates the need for the end users to manually launch the media player software when the end users desire to watch the DVD program without accessing the linked content on the ROM or the Internet. In addition, the present system is designed to automatically locate and launch resources that are available on the user's computer. For example, when an end user initiates playback of a DVD or similar media on his or her personal computer, either via disc insertion or standard methods of beginning playback in the user's specific environment, a specified web site may launch in the background (i.e., without user intervention). The present system locates and launches the appropriate applications, defined by the end user's computer as the default applications, to handle the relevant media types. The appropriate applications may include the media player and the web browser applications resident on the end user's computer system. After completing all tasks, the system terminates itself automatically.

Implementations of the content delivery system and techniques for the content delivery and control device described here may include various combinations of the following features.

In one aspect, a system is provided to communicatively link one or more resources to fixed media. The system includes a user interface device and one or more computers communicatively coupled to the user interface device. The one or more computers include a processor and a display designed to provide a graphical user interface to a user. The graphical user interface is designed to receive from the user, data used to identify the one or more resources. A server is also communicatively coupled to the one or more computers, and the server executes an application to generate a hash file based on the received data and a private seed value. The generated has file includes a first hash code. The application also generates an executable file and an output file that includes the generated hash file and the executable file. The output file is stored on fixed media.

Implementations can optionally include one or more of the following features. The output file may include a read only memory (ROM) image, and the ROM image may be stored on fixed media by burning the ROM image onto the fixed media. The data received from the user include at least one of an image, a Uniform Resource Locator (URL), or a HyperText Markup Language (HTML) file. The data received from the user may also include an index.htm file.

In another aspect, a system is provided for presenting one or more resources communicatively linked to fixed media. The system includes a user interface device and one or more computers communicatively coupled to the user interface device. The one or more computers include a processor and a display designed to activate an executable file stored on fixed media. The executable file loads an index.htm file stored on the fixed media; generates a hash code based on the index.htm file and a private seed value; loads a hash file stored on the fixed media, which the hash file including a previously stored hash code; and compares the generated hash code to the previously stored hash code to determine whether to execute one or more applications.

Implementations can optionally include one or more of the following features. The hash file may include a MD5 hash file, and the generated and previously stored hash codes may include a MD5 hash code. The system may include an operating system communicatively coupled to the processor, and the one or more computers may activate the executable file using an autorun function of the operating system. The executable file is further able to determine whether the generated hash code matches the previously stored hash code. If the two hash codes match, the executable file may (a) read information stored in a data table; (b) initialize a media player based on the read information; (c) launch a content stored on the fixed media using the media player; and (d) launch a web browser to point to a location based on the read information. The read information may include one or more URLs identifying the one or more resources located online. Alternatively the read information may include one or more addresses identifying the one or more resources located locally on the fixed media. Further, the executable file may identify one or more default applications, including a media player and a default web browser for launching.

The subject matter described herein can be implemented as a method, or as a system or using computer program products, tangibly embodied in information carriers, such as a CD-ROM, a DVD-ROM, a semiconductor memory, and a hard disk. Such computer program products may cause a data processing apparatus to conduct one or more operations described herein.

In addition, the subject matter described herein can also be implemented as a system including a processor and a memory coupled to the processor. The memory may encode one or more programs that cause the processor to perform one or more of the method acts described herein.

Details of one or more implementations are set forth in the accompanying drawings and the description below. Other features and advantages will be apparent from the description and drawings, and from the claims.

### BRIEF DESCRIPTION OF DRAWINGS

FIG. 1 is a functional diagram depicting a system for presenting a fixed media object (e.g., a DVD) communicatively linked to a supplemental content.

FIG. 2 is a flow chart depicting a process of initiating and operating a system for presenting a fixed media object communicatively linked to a supplemental content.

FIG. 3 is a block diagram depicting a system for implementing an Executable Unit to reside on a computer system.

FIG. 4 is a flow chart depicting a process of initiating and operating a system for implementing an Executable Unit to reside on a computer system.

FIG. 5 is a functional diagram of a system implementing some system components on fixed media and other system components on a computer system.

FIG. 6 is a flowchart depicting a process for initiating and operating a system implementing some system components on fixed media and other system components on a computer system.

FIG. 7 is a functional block diagram depicting a system for triggering one or more events based on a fixed media execution event.

FIG. 8 is a flowchart illustrating a process for initiating and operating a system for triggering one or more events based on a fixed media execution event.

FIG. 9 is a functional diagram of a system for operating and presenting an authoring tool for creating links to a fixed media object.

FIG. 10 is a flowchart depicting a process for operating the authoring tool.

Like reference symbols in the various drawings indicate like elements.

### DETAILED DESCRIPTION

The following describes a method and system for linking a main content to one or more specified supplemental contents for presenting to end users. For example, end users operating a DVD or similar fixed media object (e.g. CD) in a computer or similarly suitable environment capable of playing back a main content (e.g., movie or music) stored on a fixed media object may be presented with linked supplemental content while simultaneously activating an instance or instances of one or more applications such as a web browser. Supplemental content can be linked to the main content stored on a fixed media object by providing a target Uniform Resource Locator (URL) to a web browser. In addition to a web browser, the one or more applications activated can be any applications either resident locally or online (e.g., a web application) that can be used to enhance the user experience, such as playing the content stored on the fixed media, providing a user interface, presenting the linked content, etc. The method and system according to the present disclosure are platform independent, and thus are applicable to various current and future platform environments. Some of the supported platform environments may include, but are not limited to, current and future versions of personal computer operating systems (e.g. Microsoft® Windows, Apple® MacOS, and Linux/Unix), current and future mobile devices (e.g. mobile phones), current and future handheld computers or gaming consoles (e.g. PDA's, Nintendo® DS, Sony® Play Station Portable), and current and future “set-top” devices such as DVD players, gaming consoles (e.g Sony® Play Station, Microsoft® Xbox, Nintendo®Wii etc.), and digital video recorders (e.g TiVo, Microsoft® Media Center).

When an end user initiates the system according to the present disclosure, a series of predetermined commands may be issued and executed in order to accomplish a desired objective (e.g., play a main content of the fixed media object and present one or more supplemental contents linked to the end user). For example, a default media player application (e.g., a DVD-capable media player) resident on the computer may be identified and launched or activated automatically. In addition, a predetermined supplemental web site or similar content may also be automatically launched in a default web browser identified by the system. The supplemental web site or content may be launched in a separate window, either alongside or behind the media player. The system operates “in the background” (i.e., without necessitating user intervention in most scenarios) to locate, manage and launch all applications as needed. Once these commands are issued and executed, the system executes any necessary clean-up functions (e.g., re-sizing windows) and self-terminates.

The method and system described herein also simplifies the current conventional process of creating links to web pages or similar resources that are offered as part of a DVD (or similar media) user experience. The individual components of the system can be stored in various locations (e.g., on the DVD media, on the end user's computer hard drive, or online). While in some implementations, the components of the system may be stored entirely on the DVD media, other implementations may be designed so that some or all of the components may be stored on dynamic (i.e. read and write) memory resident to the end-user's native operating environment and/or remotely via the Internet or similar communication network.

The automatic functionality of the system may be realized via the standard Autorun functionality available in most operating environments. For example, in computers running Microsoft® Windows operating system, the Autorun function automatically activates an executable file stored on a fixed media (e.g., a DVD) in response to a user inserting the DVD into a DVD-ROM drive. Alternatively, the automatic functionality of the system may be implemented through an end user initiation via a runtime engine. In both instances, the system avoids permanent changes to existing operating systems. In addition, the system negates the need for the end users to have their viewing experience interrupted by prompts. The system does not force the end users to make any decisions, and does not require the end users to learn an unfamiliar user interface. End users need not replace or install any existing system hardware or software to obtain the functionality of the system.

System Components Resident on Media

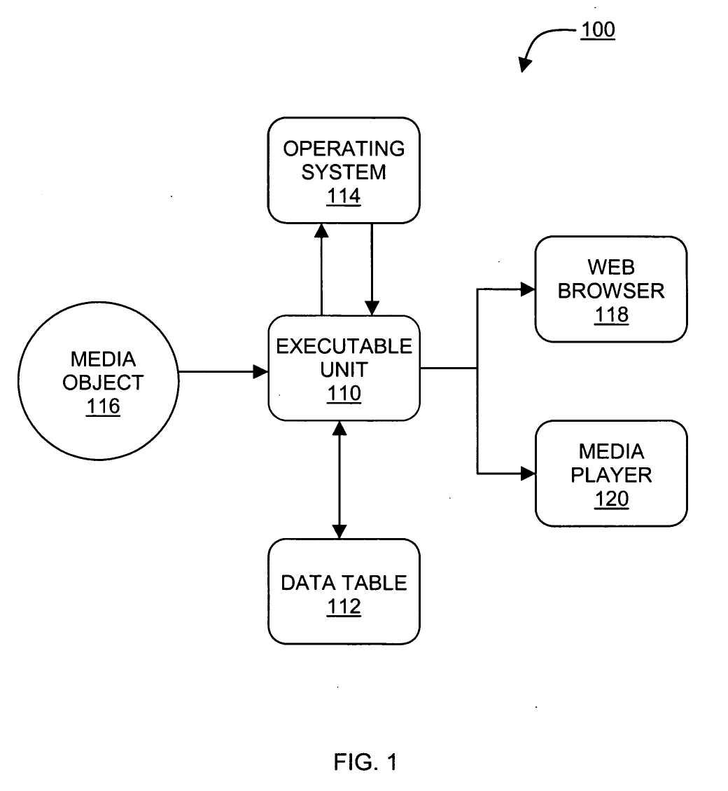

FIG. 1 is a functional diagram depicting a system 100 for presenting a main content stored on a fixed media object (e.g., a DVD) communicatively linked to a supplemental content. The system 100 may include an Executable Unit 110, a Data Table 112, an Operating System 114, a Media Object 116, a Web Browser 118, and a Media Player 120. An Executable Unit 110 manages and executes primary and supplemental application launches as defined in a Data Table 112. The Executable Unit 110 can be an executable (.exe) file generated by a computer application. The Data Table 112 may be a machine-readable file or part of a machine-readable file containing at least one uniform resource location (URL) or an Internet address or similar location path to resources located either locally (e.g., on a fixed media, such as a DVD) or externally (e.g., online). The resources can include a web site, a web page, a document, an application, an image, an audio clip, a video clip, etc. The Data Table 112 may contain additional information, such as a set of platform-dependent instructions to move or resize the Web Browser 118 window, or instructions for the Media Player 120 to start playing specified video content in a full screen window. This file may be modified by a content author during production and read by the Executable Unit 110 at runtime. The Data Table 112 is generally included in the Executable Unit, but in some implementations, the Data Table 112 may be an independent file.

A Media Object 116, may include a fixed media optical disc such as a DVD or CD. An Operating System 114 may include conventional operating systems such as Microsoft® Windows or Apple® MacOS. A Web Browser 118 may include conventional web browsers, such as Microsoft® Internet Explorer or Mozilla® Firefox. A Media Player 120, may include conventional media players, such as Microsoft® Windows Media Player, Intervideo® WinDVD, Cyberlink® PowerDVD, Apple® DVD Player, Video LAN Client, or MPlayer, etc. In one aspect, the system 100 is implemented using a series of computer executable instructions with the relevant components 110, 112, 114, 118, and 120 stored on the fixed Media Object 116.

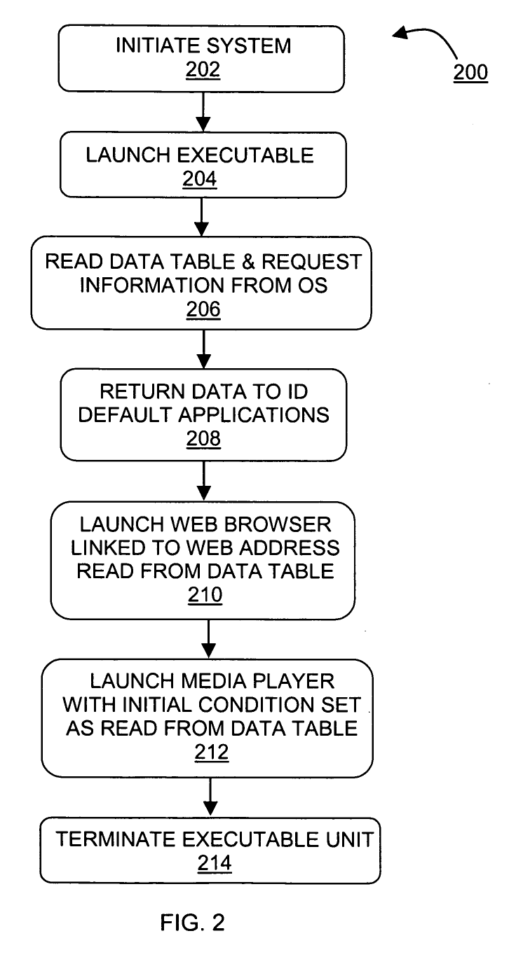

FIG. 2 is a flow chart depicting a process 200 of initiating and operating the system 100. The system 100 may be initiated at 202 when an end user inserts the Media Object 116 into a suitable Media Control Unit (e.g., a DVD player or a computer DVD-ROM drive; not shown). Alternatively, the end user may otherwise instruct the system 100 to play the Media Object 116. Once initiated, the system 100 launches the Executable Unit 110 at 204. Launching the Executable Unit 110 is implementation-dependent. For example, on the Windows operating system, the built-in autorun functionality provided by the operating system (OS) may be used to automatically activate the Executable Unit 110 in response to a fixed media object being inserted into a DVD-ROM.

The activated Executable Unit 110 performs various tasks in an attempt to present the contents of the fixed media object. An index.htm file is loaded from the fixed media. An index.htm file is a main or index web page having a URL that points to a directory rather than a file in a directory. A hash code is also generated from the index.htm file and a private seed value (this is the same process used by an application at a web site to generate the hash code when the Executable Unit 110 was previously generated and stored on the fixed media). In addition, a previously generated hash file is loaded from the fixed media object. The generated hash code is compared to the hash code in the previously generated hash file. If the two hash codes do not match, the Executable Unit 110 generates an error message and exits. No additional processes may be executed (e.g., the movie stored on the fixed media object is is not played). Alternatively, if the two hash codes match, then the Executable launches the appropriate main content (e.g., a movie or a video file) stored on the fixed media object (e.g., DVD) using the default media player defined for the system. The Execution Unit 110 identifies the default media player using an platform-dependent player lookup function. Based on the operating system running on the computer system, the method for identifying the default media player or any other default applications (e.g., a web browser) will vary. In one method, the Execution Unit 110 requests information from the Operating System 114 to identify the default media player and/or the default web browser. The Executable Unit 110 also launches the HTML content from the fixed media using the default browser defined for the system. The Browser lookup method is also implementation-dependent as described above with respect to the default media player. The Executable Unit 110 then performs an operation to ensure that the DVD video content is the active (or front) window. The active window can also be described as having focus.

The Executable Unit 110 also reads the Data Table 112 and requests information from the Operating System 114 at 206. As set forth above with respect to identifying the default media player and web browser, the information requested from the Operating System 114 can include information to identify the default applications including the default media player and web browser. In this instance, some of the information may be requested from the Operating System 114 before the Execution Unit 110 launches the default applications (e.g., media player, web browser). In response to the requests from the Executable Unit 110, the Operating System 114 returns data identifying the default applications (e.g., Web Browser 118 and Media Player 120) resident on the local computing environment at 208. In addition, the information received from the operating system may include addition information (e.g., information identifying additional applications resident on the local computing environment, information identifying default setting or values on the applications, etc.). At 210, the Executable Unit 110 launches the Web Browser 118 pointed to the Internet address read from the Data Table 112. The Executable Unit 110 launches the Media Player 120 with initial conditions set as described in Data Table 12 at 212. The Media Player 120 and the Web Browser 118 may be launched simultaneously or in sequence. The order in which the two applications are launched may vary. At the conclusion of the necessary launches and activations, the Executable Unit 110 terminates itself at 214.

The information received from the Operating System 114 in this or any other implementations may state that no default applications (e.g., a media player, web browser, etc.) are resident. In such instances, the Execution Unit 110 in this or any other implementations may search for and identify other suitable applications available external to the local computing environment (e.g., online). Therefore, an external application, such as a web application can be used to launch the main content stored on the fixed media object in this and any other implementations.

System Components Resident on Computer System

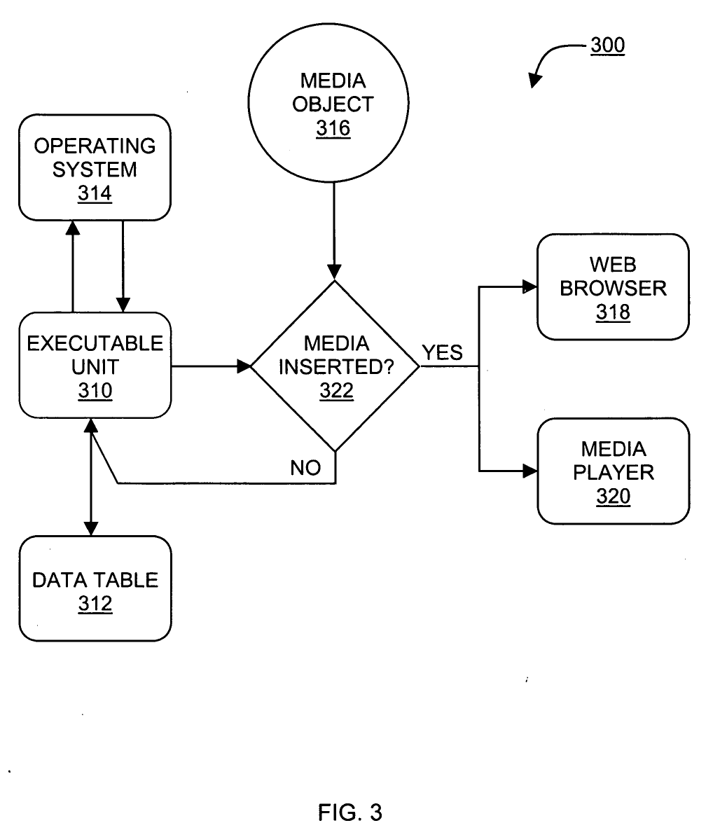

In some implementations, the system components are resident but inactive on the computer system. FIG. 3 is a block diagram depicting a system 300 for implementing an Executable Unit 310 to reside on the computer system. The system 300 further includes a Data Table 312, an Operating System 314, a Media Object 316, a Web Browser, a Media Player 320, and a Decision Unit 322. The Executable Unit 310 is in frequent communication with or embedded in the Operating System 314. The Data Table 312 is typically included in the. Executable Unit 310, but in some implementations, the Data Table 312 is an independent storage location.

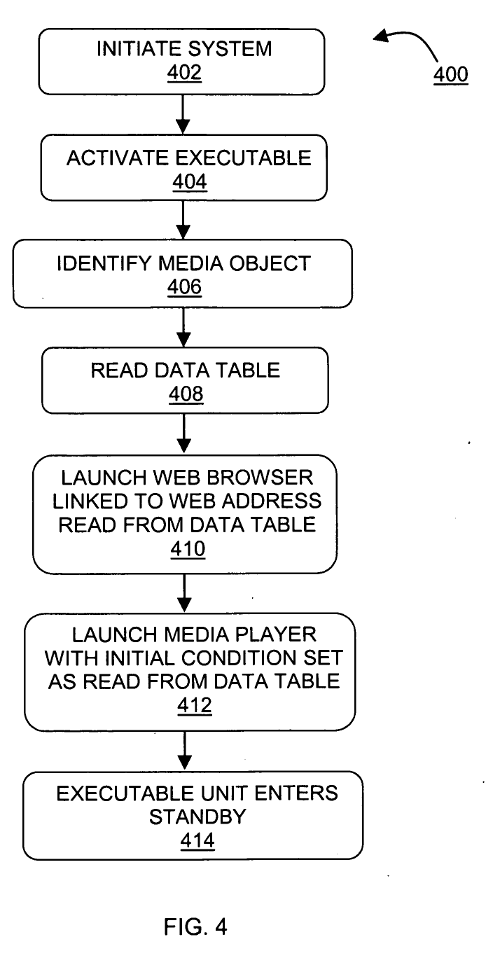

FIG. 4 is a flow chart depicting a process of initiating and operating the system 300. At 402, an end user may initiate the system 300 by inserting the Media Object 316 into a suitable Media Control Unit (e.g., a DVD player or a computer DVD-ROM drive; not shown). Alternatively, the end user may otherwise instruct the system 300 to play the Media Object 316. The Executable Unit 310 is activated at 404, and if necessary the Executable Unit 310 shuts down or prevents the launch of any autorun application sequence defined on the Media Object 316. The Executable 310 identifies the Media Object 316 at 406, reads the Data Table 312 at 408, and launches the Web Browser 318 pointed to a corresponding Internet address in the Data Table 312 at 410. At 412, the Executable Unit 310 launches the Media Player 320 with initial conditions set as described in the Data Table 312. The functions executed by the Execution Unit 310, and the information received from the Operating System 314 may be similar to those described with respect to FIGS. 1-2 above. After executing all launches, the Executable Unit 310 re-enters a non-active mode at 414, where the Executable Unit 310 remains at a stand-by mode. During the stand-by mode, the Executable Unit 310 is maintained resident on the local computer system, and the Executable Unit 310 continues to monitor the status of the Operating System 314 should subsequent events necessitate a re-activation. If such events occur, the Execution Unit 310 reactivates to perform one or more of the functions as described above.

System Components Resident on Both Media and Computer System

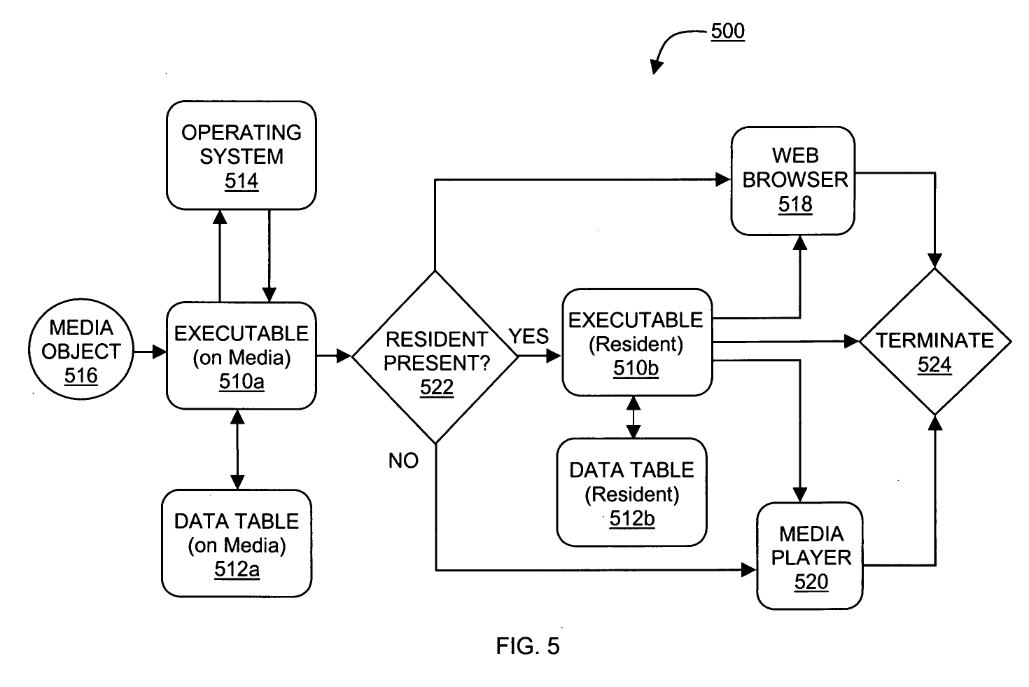

In some implementations, system components reside on both a fixed media object and a local computer system. FIG. 5 is a functional diagram of a system 500 implementing an Executable Unit 510a and a Data Table 512a stored on a Media Object 516, and an Executable Unit 510b and a Data Table 512b residing on a local computer system (not shown). The system 500 further includes an Operating System 514, a Decision Unit 522, a Web Browser 518, a Media Player 520, and a Termination Unit 524.

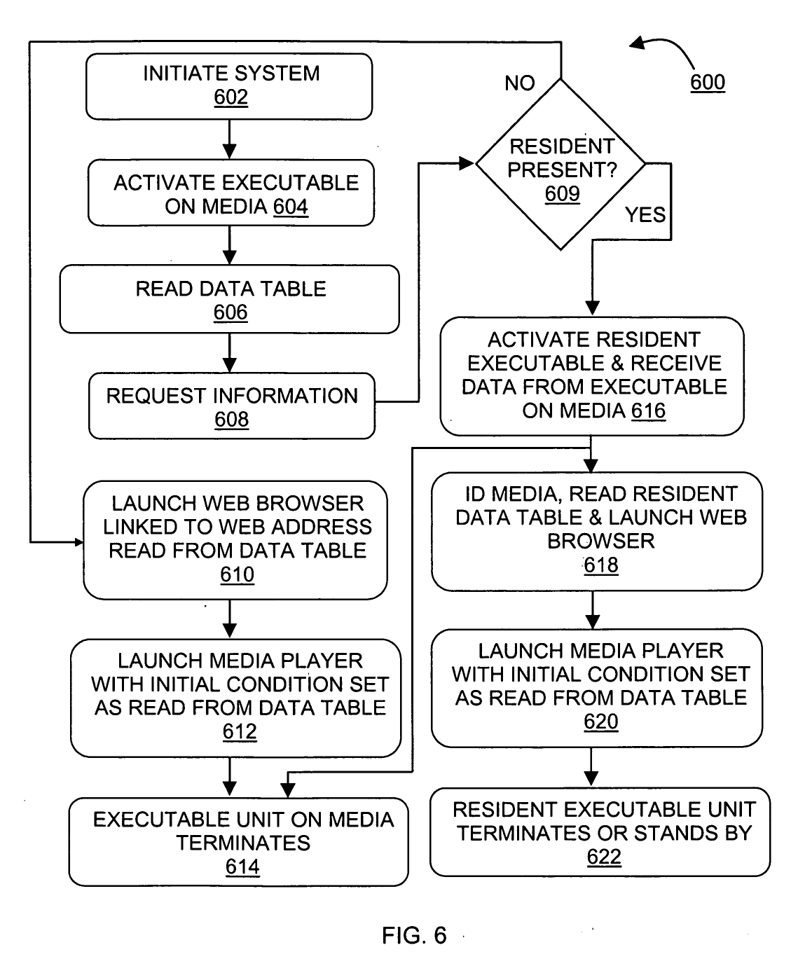

FIG. 6 is a flowchart depicting a process 600 for initiating and operating the system 500. The system 500 can be initiated by an end user inserting the Media Object 516 into a suitable Media Control Unit (e.g., a DVD player or a computer DVD-ROM drive; not shown) at 602. Alternatively, the end user may otherwise instruct the system 500 to play the Media Object 516. At 604, the Executable Unit 510a stored on the Media Object 516 is activated, and the Executable Unit 510a reads the Data Table 512a at 606. Based on the data read from the Data Table 512a, the Executable Unit 510a requests information from the Operating System 514 at 608. The Operating System 514 returns data regarding the presence of a resident Executable Unit 510b and the default software applications (e.g., a default Web Browser 518 and a default Media Player 520). In some implementations, the functions executed by the Execution Unit 510 and the information received from the Operating System 514 may be similar to those described with respect to FIGS. 1-4 above. In addition, a determination is made at 609 to decide whether an Executable Unit 510b is resident. If an Executable Unit 510b is determined, at 609, to be not resident, the Executable Unit 510a launches, at 610, the Web Browser 518 pointed to an Internet address read from the Data Table 512a. The Executable Unit 510a also launches the Media Player 520, at 612, with initial conditions set as described in the Data Table 512a. The Executable Unit 510a then terminates itself.

If a determination is made at 609 that an Executable Unit 510b is resident, the resident Executable Unit 510b is activated and the resident Executable Unit 510b receives data from the Executable Unit 510a at 616. Subsequent to handing off information to the resident Executable Unit 510(b), the Executable Unit 510a terminates itself at 614. At 618, the resident Executable Unit 510b identifies the Media Object 516, reads the Data Table 512b, and launches the Web Browser 518 pointed to the Internet address in the Data Table 512b. The resident Executable Unit 510b also launches the Media Player 520 with initial conditions set as described in the resident Data Table 512b. The resident Executable Unit 510b either terminates or stands by but stays resident and continues to monitor the status of the Operating System 514 should subsequent events necessitate that the resident Executable Unit 510b re-activate.

Multiple Links to a Plurality of Devices

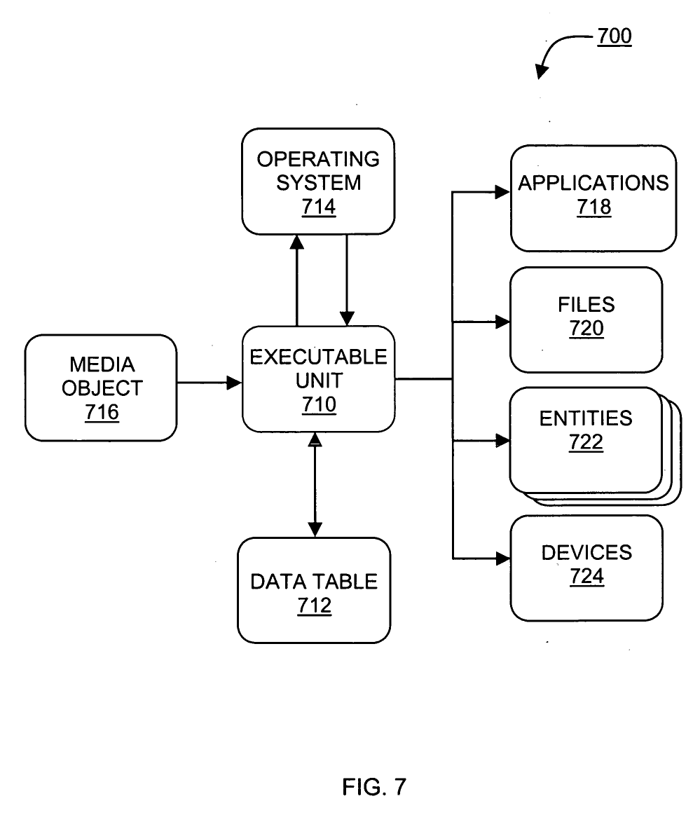

In another aspect, the method and system as described can be implemented to execute one or more events in response to an end user initiated media event. FIG. 7 is a functional block diagram depicting a system 700 for triggering one or more events based on a media execution event. The system 700 includes an Executable Unit 710, a Data Table 712, an Operating System 714, a Media Object 716, one or more Applications 718, one or more Files 720, one or more Entities 722, and one or more Devices 724. A Media Object 716 may include any suitable computer readable media (e.g., a DVD, a CD, etc.). An Application 718 may include any suitable computer software applications (e.g., a media player, a web browser, etc.). A File 720 may include any suitable computer readable or executable files (e.g., documents, executable files, system directory files, system setting files, etc.). A Device 724 may include any peripheral devices attached to the local computing environment. For example, a portable computing device (e.g., a gaming device or an external DVD-ROM) may be tethered to the local computing environment, and the Executable Unit 710 may communicate with the attached device to synchronize with the attached device. This may include downloading or copying a file or application from the attached device. An Entity 722 may include any type, number, or combination of digital or logical entities. The Entity 722 may include any digital entity that is not an executable, a file or a device. For example, the Entity 722 may include a discrete digital unit such as a variable, a string or a stub of code the executable might provide, or pass to another executable, file, device or entity. Alternativley, the Entity 722 may include a combination or array of executables, files, devices operating in concert as a digital unit, a “content bundle” or a combination or array of content operating as a digital unit. These components are communicatively linked to each other as shown by directional arrows in FIG. 7.

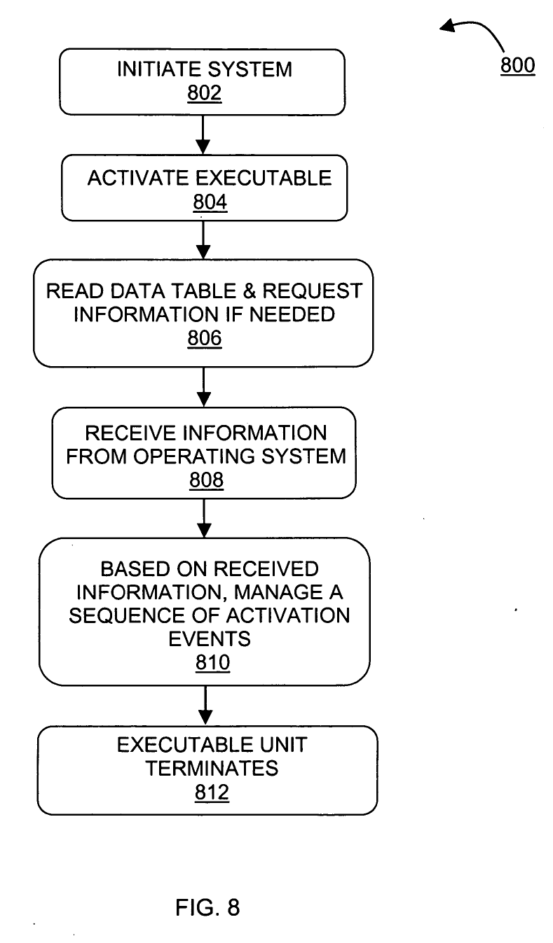

FIG. 8 is a flowchart illustrating a process 800 for initiating and operating the system 700. An end user may initiate the system 800 by inserting the Media Object 716 into a suitable Media Control Device (not shown) at 802. Alternatively, the end user may instruct the system 800 to play the Media Object 716. Once initiated, the Executable Unit 810 launches or becomes active at 804. At 806, the Executable Unit 810 reads the Data Table 712 and if needed, requests and receives information from the Operating System 714. The information requested may be regarding the location and handling of Applications 718, Files 720, Entities 722, and Devices 724. If requested, the requested information is received from the Operating System 714 at 808. Based on the received information, the Executable Unit 710 may manage a sequence of event activations at 810. For example, the events may include a sequential launch to multiple Devices 724, loading Files 720 and Entities 722, and launching Applications 718. The information received from the Operating System 714 may include information identifying all available Devices 724, Files 720, Entities 722, and Applications 718 either resident locally or online. In addition, the received information may include settings or properties of the Devices 724, Files 720, Entities 722, and Applications 718. The received information may also include additional information to activate or load the Devices 724, Files 720, Entities 722, and Applications 718. For example, additional information may include a predetermined sequence for activating or loading the Devices 724, Files 720, Entities 722, and Applications 718. After the Executable Unit 710 completes the sequential activation or loading of Devices 724, Files 720, Entities 722, and Applications 718, the Executable Unit terminates or enters a stand-by mode at 812.

Authoring Tool

In one aspect, an authoring tool is provided to facilitate packaging of a fixed media object to include a main content and links to supplemental content located locally and/or externally as described above with respect to FIGS. 1-8. The authoring tool is presented to a user through a graphical user interface (GUI), and through the GUI, information is received from the user. Using the GUI, the information is typically uploaded from the user's computer system to a central server that executes an application to process the uploaded information.

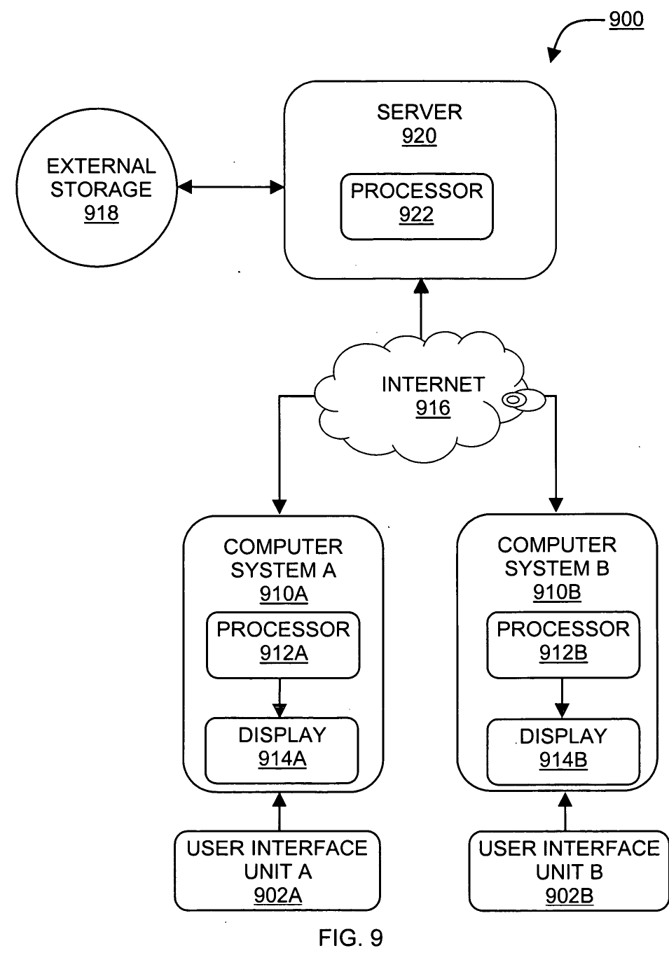

FIG. 9 depicts a functional diagram of a system 900 for operating and presenting an authoring tool for creating links to a fixed media object. The system may include multiple computer systems 910A, 910B with each computer system communicatively coupled to one or more user interface units 902A, 902B. The computer systems 910A, 910B can include personal computers, such as a desktop computer; a portable computer, such as a laptop computer; a mobile computing device such as a PDA, smart phone, and a cell phone; and other suitable computing devices. The user interface units 902A, 902B can include a mouse, keyboard, light pen, a touch pad, and other suitable user input devices. The user input units 902A, 902B enable one or more users to interact with the computer systems 910A, 910B. The computer systems 910A, 910B are communicatively coupled to a server 920 using a wired or a wireless communication medium. For example, the computer systems 910A, 910B may be communicatively linked to the server 920 through the internet 916. Alternatively, the computer systems 910A, 910B may be communicatively linked to the server 920 through a local network, such as a wide area network (WAN). Thus, the multiple computer systems 910A, 910B may be located at a site remote from the server 920. The server 920 in turn may be communicatively coupled to an external storage device 918.

The computer systems 910A and 910B may include a processor 912A, 912B and a display 914A, 914B. Each of the processors 912A and 912B is capable of running an operating system (not shown), and through the operating system, various software applications may also be executed. For example, a GUI (not shown) may be presented to a user by displaying the GUI on the display 914A, 914B. Through the GUI presented on the displays 914A and 914B, one or more users may submit information (e.g., images, HTML files, video files, etc.), which is uploaded to the server 920 for processing. The server 920 also includes a processor 922, which may be capable of executing an appropriate application for processing the information uploaded form the computer systems 910A, 910B.

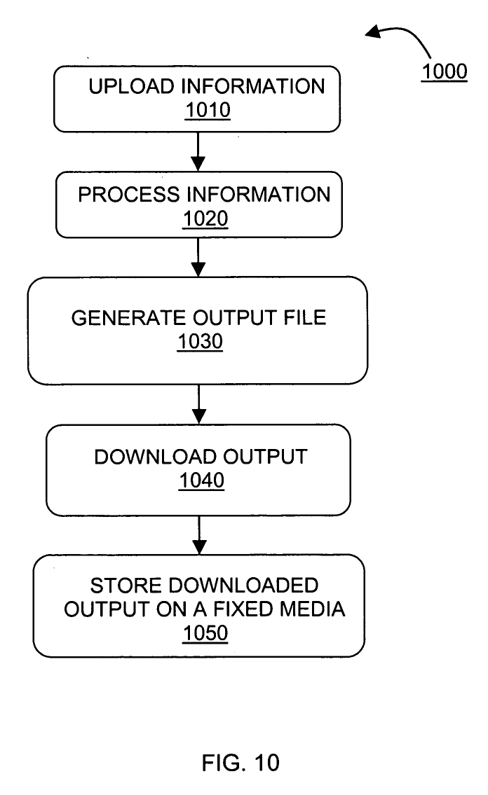

FIG. 10 is a flowchart depicting a process 1000 for operating the authoring tool. At 1010, a user uploads information to the server 920. The access to the server 920 (through a GUI) can be restricted by a security measure. For example, an ID and a password may be required. The information uploaded may include various file types including images, video files, audio files, documents, Uniform Resource Locators (URLs), HyperText Markup Language (HTML) files, etc. The user may upload an index.htm file, which is a traditional filename for a main or index page provided to a HTTP client (e.g., a web browser) that points to a directory rather than a file within a directory. Along with the index.htm file, the user may upload images to accompany the index.htm file or a list of URLs for locating one or more resources. Thus, the index.htm file can be used to link locally stored resources (e.g., uploaded images) or externally stored resources (e.g., web sites pointed to by the URLs). Alternatively, the user may simply upload a list of URLs and/or images without having to upload an index.htm file.

Once all information is uploaded by the user, the server 920 executes one or more applications to process the uploaded information at 1020. Processing the uploaded information may include accomplishing various tasks. A hash file (e.g., a Message-Digest algorithm 5 (MD5) hash file) is generated using the uploaded information. MD5 is a widely-used cryptographic hash function with a 128-bit hash value. MD5 has been widely applied, as an Internet standard (RFC 1321), in a wide variety of security applications. In addition, MD5 is commonly used to check the integrity of files. For example, MD5 digests have been widely used in software applications to guarantee the integrity of a downloaded file. A user can compare a published MD5 sum with the checksum of a downloaded file. The generated MD5 hash file contains an encrypted string of characters (e.g., a has code) that is unique to the code present in the uploaded HTML file (i.e., the index.htm file). In addition, a private seed value is used temporarily during the generation of the hash file to ensure a unique has code for each user session.

In addition, an output file is generated to include an autorun.inf file, an executable file the HTML file (e.g., the index.htm file) with associated image files (if any were uploaded), and the hash file at 1030. The autorun.inf file is used to take advantage of the Autorun functionality of most operating systems to automatically activate the executable file. The executable file includes instructions to execute playback of any main content (e.g., a movie) stored on a fixed media, such as a DVD. In addition, the executable file is capable of executing applications to present any supplemental content linked to the fixed media (e.g., launching a web browser to point to an online web site). The HTML file provides a directory of the linked resources, and any images uploaded can be stored locally on the fixed media. The generated output file is provided to the user at 1040. For example, the output file may be download by the user. To facilitate the download process, the output file may be compressed (e.g., zipped). In addition, the output file may be generated as a read-only-memory (ROM) image, which may be burned on a fixed media object for permanent storage at 1050. Typically, a main content, such as a movie is burned along with the ROM image in order to link the movie stored on a fixed media object with either locally stored or online supplemental content. The main content (e.g., a movie) stored on the fixed media object and the linked supplemental content is presented to the user as described above with respect to FIGS. 1-8 above.

Although a few variations have been described in detail above, other modifications are possible. For example, the logic flow depicted in the accompanying figures and described herein do not require the particular order shown, or sequential order, to achieve desirable results.

Other possible modifications may include the following: (1) the method and system as described herein may be applied to a media format other than a DVD, such as a CD, Blu-ray Disc, HD-DVD, UMD, streaming and/or cached media and/or future formats that can play on a computer or similar environment; (2) instead of launching a Web browser (e.g., 118, 318, 518), an Executable Unit (e.g., 110, 310, 510, 710) may be implemented to launch other suitable application(s) or file(s); (3) instead of launching a single secondary Web Browser (e.g., 118, 318, 518) in addition to the Media Player (e.g., 120, 320, 520) multiple instances of windows or multiple application processes may be launched; (4) instead of launching the default Web Browser (e.g., 118, 318, 518) or Media Player (e.g., 120, 320, 520) or applications determined to handle a specific file or media type as defined by the operating system environment, a specific Web Browser or Media Player or other application that may or may not be the default Browser, player or application, may be launched; (5) instead of performing all tasks in the background, the end user may be notified with status information from the system (e.g., 100, 300, 500, 700), and/or the flow of tasks may be interrupted with confirmation windows or choices presented to the end user; (6) the Executable Unit (e.g., 110, 310, 510, 710) may be implemented to not self-terminate; (7) the Executable Unit (e.g., 110, 310, 510, 710) and Data Table (e.g., 112, 312, 512, 712) may be encrypted or unencrypted, compiled or un-compiled; (8) the Executable Unit (e.g., 110, 310, 510, 710) may send requests to the Operating System (e.g., 114, 314, 514, 714) either before or after it reads the Data Table 12, with either event occurring first or both simultaneously if the object is achieved; (9) the Executable Unit (e.g., 110, 310, 510, 710) may launch the Web Browser (e.g., 118, 318, 518) either before or after launching the Media Player (e.g., 120, 320, 520), with either event occurring first or both occurring simultaneously if the object is achieved; (10) the Executable Unit (e.g., 110, 310, 510, 710) may be implemented to make requests to the Operating System (e.g., 114, 314, 514, 714) using information contained in the Data Table (e.g., 112, 312, 512, 712); (11) the Executable Unit (e.g., 110, 310, 510, 710) may be implemented to request information from the Operating System (e.g., 114, 314, 514, 714) more than once during runtime; (12) the Executable Unit (e.g., 110, 310, 510, 710) may launch the Web Browser (e.g., 118, 318, 518) or Media Player (e.g., 120, 320, 520) indirectly, either by sending a message to the Operating System (e.g., 114, 314, 514, 714) or by any other indirect means; (13) the Data Table (e.g., 112, 312, 512, 712) may be stored online, cached or otherwise stored on the end user system; (14) the Data Table (e.g., 112, 312, 512, 712) can be dynamically created at runtime; (15) instructions/commands to store the Data Table (e.g., 112, 312, 512, 712) on rewriteable media such as a user hard drive and the Data Table (e.g., 112, 312, 512, 712) itself may be part of a system having dynamic and updated supplemental content; and (16) the Executable Unit (e.g., 110, 310, 510, 710) may be implemented to request updated information from the Internet to add or change the content of the Data Table (e.g., 112, 312, 512, 712).

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “information carrier” comprises a “machine-readable medium” that includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (LAN), a wide area network (WAN), and the Internet.

The computing system may include clients and servers. A client and server are generally remote from each other and typically interact through a communication network. The relationship of client and server arises by virtue of computer programs running on the respective computers and having a client-server relationship to each other.

A number of implementations of the disclosure has been described. Nevertheless, it will be understood that various modifications may be made without departing from the scope of the disclosure including the claims.

What is claimed is:

1. A method for communicatively linking supplemental content to main content, the method comprising:
providing a user interface operative to receive data from a user, the received data including information identifying one or more items of the supplemental content;
based on the received data, generating an executable file operable to control presentation of the one or more supplemental contents in conjunction with the main content; and
generating an output file including the executable file.

2. The method of claim 1, further comprising
generating a private seed value to provide a unique signature to a hash algorithm;
generating a hash file based on the received data and the generated private seed value, the hash file including a hash code identifying the received data; and
wherein generating the output file further comprises including the hash file in the output file.

3. The method of claim 1, further comprising storing the generated output file on a fixed media object.

4. The method of claim 1, wherein generating an output file further comprises generating a read only memory (ROM) image.

5. The method of claim 4, wherein storing the output file further comprises burning the ROM image onto the fixed media object.

6. The method of claim 1, further comprising providing the user interface to receive from the user at least one of an image, a Uniform Resource Locator (URL), or a HyperText Markup Language (HTML) file.

7. The method of claim 1, further comprising providing the user interface to receive an index.htm file identifying a location of the one or more supplemental contents.

8. A method of presenting supplemental content communicatively linked to main content, the method comprising:
providing a fixed media object storing an executable file and main content; and
activating the executable file stored on the fixed media object, the executable file operable to launch one or more applications to present the main content in conjunction with the supplemental content.

9. The method of claim 8, wherein activating the executable file further comprises
loading an index.htm file from the fixed media object;
generating a hash code based on the index.htm file and a private seed value;
loading a hash file from the fixed media object, the hash file including a previously stored hash code; and
comparing the generated hash code to the previously stored hash code to determine whether the hash codes match and, if the hash codes match, launching the one or more applications.

10. The method of claim 8, wherein launching the one or more applications further comprises,
(a) reading information stored in a data table communicatively coupled to the executable file,
(b) initializing a media player based on the read information,
(c) launching the main content stored on the fixed media using the media player, and
(d) launching a web browser to pointed to a location based on the read information.

11. A system for communicatively linking supplemental content to main content, the system comprising:
a user interface device;
one or more computers communicatively coupled to the user interface device, the one or more computers including a processor and a display configured to provide a user interface to a user, wherein the user interface is operative to receive data identifying one or more items of supplemental content; and
a server communicatively coupled to the one or more computers, the server executing an application operable to
generate, based on the received data, an executable file operable to control presentation of the one or more items of supplemental content in conjunction with the main content; and
generate an output file including the executable file.

12. The system of claim 11, further comprising
a private seed value to provide a unique signature to a hash algorithm;
a hash file generated using the hash algorithm and based on the received data and the generated private seed value, the hash file including a hash code identifying the received data; and
wherein the output file includes the hash file.

13. The system of claim 11, further comprising storing the generated output file on a fixed media object.

14. The system of claim 11, wherein the output file comprises a read only memory (ROM) image.

15. The system of claim 14, wherein the ROM image is burned onto a fixed media object.

16. The system of claim 11, wherein the data received from the user comprises at least one of an image, a Uniform Resource Locator (URL), or a HyperText Markup Language (HTML) file.

17. The system of claim 11, wherein the data received from the user comprises an index.htm file identifying a location of the one or more items of supplemental content.

18. The system of claim 12, wherein the hash file comprises a MD5 hash file and the generated and previously stored hash codes comprise a MD5 hash code.

19. The system of claim 12, further including an operating system communicatively coupled to the processor, wherein the one or more computers are configured to activate the executable file using an autorun function of the operating system.

20. A system for presenting supplemental content communicatively linked to main content, the system comprising:
a user interface device; and
one or more computers communicatively coupled to the user interface device, the one or more computers including a processor and a display configured to
access a fixed media object storing an executable file and the main content; and
activating the executable file stored on a fixed media object, the executable file operable to launch one or more applications to present the main content in conjunction with one or more items of supplemental content.

21. The system of claim 20, wherein the executable file is further operable to
load an index.htm file from the fixed media object;
generate a hash code based on the index.htm file and a private seed value, and
load a hash file from the fixed media object, the hash file including a previously stored hash code; and
compare the generated hash code to the previously stored hash code to determine whether the hash codes match, and if the hash codes match, launching the one or more applications.

22. The system of claim 21, wherein the executable file is further operable to, if the generated hash code matches the previously stored hash code,
(a) read information stored in a data table communicatively coupled to the executable file;
(b) initialize a media player based on the read information;
(c) launch the main content stored on the fixed media object using the media player; and
(d) launch a web browser to point to a location based on the read information.

23. The system of claim 22, wherein the read information comprises one or more URLs identifying the one or more resources located online.

24. The system of claim 22, wherein the read information comprises one or more addresses identifying the one or more items of supplemental content.

25. The system of claim 20, wherein the executable file is further operable to identify a default media player and a default web browser for launching.

26. A computer program product, encoded on a computer-readable medium, operable to cause data processing apparatus to perform operations comprising:
providing a user interface operative to receive data from a user, the received data including information identifying one or more items of supplemental content;
generating, based on the received data, an executable file operable to control presentation of the one or more supplemental contents in conjunction with a main content; and
generating an output file including the executable file.

27. The computer program product of claim 26, wherein the product is further operable to cause data processing apparatus to
generate a private seed value to provide a unique signature to a hash algorithm;
generate a hash file based on the received data and the generated private seed value, the hash file including a hash code identifying the received data; and
wherein generating the output further comprises including the hash file in the output file.

28. The computer program product of claim 26, wherein the product is further operable to cause data processing apparatus to store the generated output file on a fixed media object.

29. The computer program product of claim 26, wherein the product is further operable to cause data processing apparatus to generate the output file to include a read only memory (ROM) image.

30. The computer program product of claim 29, wherein the product is further operable to cause data processing apparatus to store the output file by burning the ROM image onto the fixed media object.

31. The computer program product of claim 26, wherein the product is further operable to cause data processing apparatus to provide the user interface configured to receive, from the user, at least one of an image, a Uniform Resource Locator (URL), or a HyperText Markup Language (HTML) file.

32. The computer program product of claim 26, wherein the product is further operable to cause data processing apparatus to provide the user interface configured to receive, from the user, an index.htm file identifying a location of the one or more items of supplemental content.

33. The computer program product encoded on a computer-readable medium, operable to cause data processing apparatus to perform operations comprising:
reading a fixed media object storing an executable file and main content; and
activating the executable file stored on the fixed media object, the executable file operable to launch one or more applications to present the main content in conjunction with one or more items of supplemental content.

34. The computer program product of claim 33, wherein the product is further operable to cause data processing apparatus to:
load an index.htm file from the fixed media object;
generate a hash code based on the index.htm file and a private seed value;
load a hash file from the fixed media object, the hash file including a previously stored hash code; and
compare the generated hash code to the previously stored hash code to determine whether the hash codes match and, if the hash codes match, launching the one or more applications.

35. The computer program product of claim 34, wherein the product is further operable to cause data processing apparatus to, if the hash codes match:
(a) read information stored in a data table communicatively coupled to the executable file;
(b) initialize a media player based on the read information;
(c) launch the main content stored on the fixed media using the media player; and
(d) launch a web browser to point to a location based on the read information.
